(19) United States
(12) Patent Application Publication
(10) Pub. No.: US 2002/0137413 A1
(43) Pub. Date: Sep. 26, 2002

(54) Protective hood

(76) Inventor: Rolf Heiland, Magstadt (DE)

Correspondence Address: KRIEGSMAN & KRIEGSMAN, 665 FRANKLIN STREET, FRAMINGHAM, MA, 01702, US

(21) Appl. No.: 09/836,557

(22) Filed: Apr. 17, 2001

(30) Foreign Application Priority Data
Jan. 23, 2001 (DE) 20101155.7

(51) Int. Cl. D04H 1/00; B32B 5/02

(52) U.S. Cl. 442/85; 442/409; 442/131; 442/136

(57) ABSTRACT

A protective hood, particularly for automobiles, machines and the like, comprised of a composite material with a support material of nonwoven polypropylene and a coating material of a thermoplastic copolymer. According to the invention, the coating material is comprised of an ethylene-butyl acrylate copolymer and is introduced onto the support material by means of extrusion coating.

The present invention concerns a protective hood, particularly for automobiles, machines and the like, comprised of a composite material with a support material of nonwoven polypropylene and a coating material of a thermoplastic copolymer.

A protective hood of this kind for automobiles, automobile parts, machine parts and the like is known from the German Utility Model 299 07 857.4. Such protective hoods will prevent external actions on the enveloped object, such as [the actions of] dust, dirt and water, as well as mechanical damage such as scratching and abrasion, and inhibit the formation of condensation and damming of moisture on the enveloped object. The protective hood of this type is comprised of a material which is permeable to light, moisture and air from the inside, and, on the outside, is UV-stable, alkali-stable, cannot be penetrated by water and dust, and can be printed on. This material involves a composite material, namely a nonwoven material, which is combined with a stitched foil material by means of an adhesive to form one piece. The nonwoven material thus forms the inside of the protective hood and the plastic forms the outside. The protective hood of this type is thus able to breathe, so that water of condensation cannot deposit on the enveloped object, for example, an automobile, and at the same time, the covered object is protected against external actions.

The nonwoven material used in this type of protective hood is comprised of chemical or natural fibers, and the foil material is comprised of a thermoplastic copolymer. The adhesive used involves a cold-hardening or hot-hardening adhesive based on acrylic, a cold-hardening or hot-hardening one-component or two-component adhesive or a hot-hardening reactive adhesive.

It has now turned out that the material of the protective hood of this type does not offer optimal protection against water of condensation and external influences. In particular, it has been determined that very fine dust settles on the enveloped object. This ultrafine dust acts on the lacquer surface of automobiles like abrasive [emery] paper, i.e., ultrafine scratches are formed.

The object of the present invention consists of making available an improved protective hood, which offers an optimal protection against water of condensation and external influences, particularly ultrafine dust.

The solution consists of a protective hood with the features of claim 1. According to the invention, it is thus provided that the coating material is comprised of an ethylene-butyl acrylate copolymer and is introduced onto the support material by means of extrusion coating.

The protective hood according to the invention is characterized by an excellent mechanical strength as well as an optimal temperature, UV and chemical stability. The protective hood is air-tight and sealed against dust. No ultrafine dust settles on the enveloped object. The protective hood according to the invention is also impermeable to water from the outside, but is sufficiently permeable to water vapor in both directions and is thus able to breathe, so that water of condensation cannot deposit on the enveloped object or mold stains do not form on the nonwoven material or parts of the automobile body.

It is important that the coating material is not stitched onto the support material. In this way, a particularly high stability relative to water pressure can be achieved (more than 0.5 bar per 100 cm² compared with 25 mbars in the case of a stitched composite material). Since an adhesive can be dispensed with, the protective hood according to the invention can be manufactured in a particularly economical manner, since one process step is omitted in the manufacture. In addition, the protective hood according to the invention is free of solvent due to the fact that the composite material used does not contain adhesive.

The production by extrusion coating has the advantage that one working step is spared due to the direct application of the film, as opposed to foil lamination, whereby the protective hood according to the invention can be manufactured overall in a more economical manner. This type of manufacture also permits the use of solvent-free materials that are ecologically unobjectionable. The coating layer also sufficiently protects the nonwoven material that is used in order to achieve a good stability and long service life.

Advantageous further enhancements result from the subclaims.

The basis weight of the nonwoven material, which preferably involves a filament nonwoven material with thermal bonding, may amount to between 12 and 200 g/m², preferably between 50 and 90 g/m², since these values are optimal for mechanical strength and economics. The coating material preferably has a butyl acrylate content of 17 wt. %, with which it can be processed particularly well. The coating weight of the coating material may lie between 10 and 150 g/m², preferably between 20 and 40 g/m². The coating can be made thicker or thinner, depending on whether the protective hood will serve as a stationary protective hood or is a protective hood used in transport.

The fibers of the nonwoven material and/or the coating material can be colored or may contain additives, for example, UV stabilizers or flame-protection agents. It is particularly advantageous if the coating material is free of solvents and plasticizers. It is then permissible for [use with] food products and is unobjectionable relative to health and can be completely recycled. No by-products that are harmful to the environment are formed in its combustion.

An example of embodiment of the present invention is explained in more detail below.

The protective hood according to the invention is comprised of two materials, a support material and a coating material. The support material is a polypropylene filament nonwoven material, natural, with a basis weight of 90 g/m². The filament nonwoven material can be colored. A suitable filament nonwoven material is, for example, offered by the Freudenberg Co., nonwoven material KG under the name Lutrasil LS 3450. It has a thickness of 0.43 mm (according to EN [European Standard] 29073, Part 1), a maximum tensile [strength] force of 141 N/5 cm lengthwise and 75 N/5 cm crosswise (according to EN 29073, Part 3), a maximum tensile elongation of 102% lengthwise and 97% crosswise (according to EN 29073, Part 3) and a tear strength of 15% lengthwise and 15% crosswise (according to DIN [German Industrial Standard] 53859, Sheet 3).

The coating material is an ethylene-butyl acrylate copolymer with a butyl acrylate fraction of 17 wt. %. It contains no additives. The material is particularly suitable for extrusion coating, since it has a high flexibility and a good stability, even at low temperatures. A suitable material is offered, for example, by the company Borealis Holding A/S under the name Borflex EBA OE6417. This material has a flow index of 7 g/10 min at 190° C. and 2.16 kg (according to ISO 1133), a density of 924 kg/m³ (according to ISO 1183), a minimum coating weight of 6 g/m² (according to BTM 00117) a maximum coating weight of 550 m/min (according to BTM 0016), a Vicat softening point of 55° C. (10 N; according to ISO 306), a Shore hardness (A/D) of 89/31 (according to ISO 868), a tensile modulus of 40 MPa and an extrusion edge runoff of 60 mm (according to BTM 00115). The material is free of plasticizers and solvents.

The composite material of the support material and the coating material is manufactured in a way known in and of itself by means of extrusion coating of the nonwoven material. For this purpose, the described ethylene-butyl acrylate copolymer was liquefied to a polymer melt in the extruder under a pressure of up to approximately 130 bars and with a mass temperature of 270° C. and introduced into a slit-dye tool to the appropriate finished width, for example, 150.5 cm. The liquid melt is pressed into the nonwoven material in the known way at 10° C. with 20 bars of pressure between cooled rollers, so that it solidifies into a film and enters into a permanent bond with the nonwoven material. The layer weight preferably amounts to 30 g/m². However, it can vary according to the application requirement.

The described composite material was subjected to a material testing. The test results are compiled in the following Table 1.

TABLE 1

| | Test | | Tolerance | | |
|---|---|---|---|---|---|
| Test | method | Theoretical | min | max | Actual |
| Finished weight | DIN 53352 | 80 g/m² | 72 g/m² | 88 g/m² | 84.6 g/m² |
| Crude weight | DIN 53352 | 50 g/m² | 45 g/m² | 55 g/m² | 50 g/m² |
| Coating weight | — | 30 g/m² | 27 g/m² | 33 g/m² | 30 g/m² |
| Maximum tensile | DIN 53354 | 96 N/5 cm | 96 N/5 cm | unlimited | 96 N/5 cm |
| force (lengthwise) | | | | | |
| Maximal tensile force | DIN 53354 | 85 N/5 cm | 85 N/5 cm | unlimited | 91 N/5 cm |
| (crosswise) | | | | | |
| Maximal tensile | DIN 53354 | 48% | 35% | 60% | 52% |
| force-elongation | | | | | |
| (lengthwise) | | | | | |
| Maximal tensile | DIN 53354 | 68% | 55% | 80% | 71% |
| force-elongation | | | | | |
| (crosswise) | | | | | |
| Bonding check | QMH IV-7 | ok | | | ok |
| Water-vapor | DIN 52615 | 30 g/m²xd | 30 g/m²xd | unlimited | 43.8 g/m²xd |
| permeability | | | | | |
| (climate: 38-0/90) | | | | | |
| UV stability | following | >6 months | >6 months | unlimited | >6 months |
| | prEN 1297 | (ME) | (ME) | | (ME) |
| Water pressure | EN 20811 | 5 m/100 cm² | 5 m/100 cm² | unlimited | 6 m/100 cm² |
| stability | | | | | |

The finished composite material was processed into a protective hood for automobiles. The protective hood was stable against external influences, even against UV radiation, although the coating material contains no additives, and showed an excellent water-vapor permeability, so that no water of condensation deposits on the vehicle. The weathering test, which was conducted at 500 h duration (equivalent to ½ year of weathering in Central Europe) showed no noteworthy changes. The composite material is permissible for [use with] foodstuffs and is unobjectionable to health and can be fully recycled. No by-products are formed that are hazardous to the environment in its combustion.

What is claimed is:

1. Protective hood, particularly for automobiles, machines and the like, comprised of a composite material with a support material of nonwoven polypropylene and a coating material of a thermoplastic copolymer, characterized by the fact that the coating material is comprised of an ethylene-butyl acrylate copolymer and is introduced onto the support material by means of extrusion coating.

2. Protective hood according to claim 1, further characterized in that the ethylene-butyl acrylate copolymer has a butyl acrylate content of 17 wt. %.

3. Protective hood according to one of the preceding claims, further characterized in that the support material is a filament nonwoven material, whereby the nonwoven material is bonded by means of a thermal bonding.

4. Protective hood according to one of the preceding claims, further characterized in that the basis weight of the support material amounts to between 12 and 200 g/cm², preferably between 50 and 90 g/cm².

5. Protective hood according to one of the preceding claims, further characterized in that the coating weight of the coating material lies between 10 and 150 g/cm², preferably between 20 and 40 g/cm².

6. Protective hood according to one of the preceding claims, further characterized in that the support material and/or the coating material are colored.

7. Protective hood according to one of the preceding claims, further characterized in that the support material and/or the coating material contain additives, particularly a UV stabilizer or a flame-protection agent.

8. Protective hood according to one of the preceding claims, further characterized in that the coating material is free of plasticizers and solvents.

9. Protective hood according to one of the preceding claims, namely a protective hood for automobiles or automobile parts.
